(19) United States
(12) Patent Application Publication
(10) Pub. No.: US 2026/0175424 A1
(43) Pub. Date: Jun. 25, 2026

(54) ROTARY CRANKPIN TURNTABLE ACTUATOR FOR INDUSTRIAL AUTOMATION

(71) Applicant: Sergio Enrique Castellanos Villanueva, Zapopan (MX)

(72) Inventor: Sergio Enrique Castellanos Villanueva, Zapopan (MX)

(21) Appl. No.: 19/125,195

(22) PCT Filed: Jul. 20, 2023
(86) PCT No.: PCT/MX2023/050045

§ 371 Date: Apr. 28, 2025

(30) Foreign Application Priority Data
Oct. 27, 2022 (MX) MX/A/2022/013523

(51) Int. Cl. B25J 9/16

(52) U.S. Cl. CPC B25J 9/1664; B25J 9/1689

(57) ABSTRACT

The present disclosure relates to a rotary crankpin turntable actuator whose basic operation concept involves moving a product or workpiece instead of moving a tool. The actuator eliminates the need to use robotic arms for repetitive automated manufacturing. Instead, only one fixed tool is needed. The actuator will perform the necessary motions to work the piece. The rotary crankpin turntable creates a desired trajectory (7) in one or more defined dispensing-inspection-assembly (DIA) points (5) and is made up of four components: a rotary crankpin (1), a center shaft (2), a pinion (3), and a transporter (4). It has a gear-based motion transmission system for the rotary crankpin's (1) positioning.

### CROSS-REFERENCE TO RELATED APPLICATIONS

This application is a U.S. National Phase filing under 35 U.S.C. § 371 of International Application No. PCT/MX2023/050045, filed Jul. 20, 2023, and published as WO 2024/091107-A1 on May 2, 2024, which claims priority to Mexican Patent Application No. MX/a/2022/013523, filed Oct. 27, 2022, the entire disclosures of which are hereby incorporated herein by reference.

### FIELD

The present disclosure relates to a high precision 2D positioning system, which is an alternative to robotic arms or applications requiring XY motion to position products or sub-assembly on different XY motion axes.

In addition, the present disclosure relates to an actuator for automation with various applications.

### BACKGROUND

In the field of automation, there are different applications to generate motion, such as robotic arms, XY motion systems or linear XY actuators.

Automation requirements in different fields go from all kinds of adhesive applicators, including liquid, viscous or solid; welding of electronic circuit, components, or cables with any metal, paste or plasma; micro welding of integrated circuits; arc welding; tin welding; liquid shakers with any application in workshops, factories and laboratories; paint applicators; template cutters for stickers, packaging, cardboard, steel, and plastic; screwdriver applications, sewing; watchmaking, etc.

All the robotic systems found in the state of the art are complex, expensive and allow only limited work.

There is no knowledge of the existence of planetary systems in state-of-the-art devices that could efficiently be an alternative to a repetitive manufacturing system similar to robotic arms.

### SUMMARY

The inventor has state of the art knowledge. After more than 20 years of experience in the electronics industry, developing applications for solutions automation, he got the idea of a simple actuator that could generate orbital motions having a dispensing/inspection/assembly (DIA) point in the XY plane. Once the first prototype was created, it was clear that this innovation had several uses. It can be employed for applications of different weights, precisions, and shapes within the range or pre-established area in the XY plane. This equipment usually has a complex structure with several components such as pistons, servos, or XY systems that elevate the cost and are difficult to install, use, maintain and adapt, plus to not being reusable in other applications.

With its programmable actuator, the present disclosure provides an alternative to any repetitive automation system such as robotic arms. Moreover, the simplicity of its components allows the user to build the actuator according to their specific needs. This means any size or dimension in the work area.

To provide the user with an actuator capable of repetitive high precision motion and positioning in an XY plane, with a simple mechanism of internal components, free of calibration, and reusable in case of changes in its applications and requirements. With less space required for its operation, lower implementation cost, lower energy consumption, smaller dimensions in the device. Easier to adapt in many different applications, in addition to great advantage of miniaturization.

Furthermore, to provide the user with a system that allows the motion of the tool or workpiece, or both at the same time.

The present disclosure relates to a two-dimensional (2D) planetary motion actuator that generates a desired trajectory (7) in one or more defined DIA points (5), which includes: a rotary crankpin (1); a center shaft (2); a pinion (3); and a transporter (4).

The center shaft (2) is mechanically connected to the rotary crankpin (1), and when it starts a rotational motion, it rotates the rotary crankpin (1). The pinion (3) is mechanically connected to the transporter (4), and when it starts a rotational motion, it rotates the transporter (4). The rotary crankpin (1) is mechanically connected to the transporter (4), whose center is concentric with the center shaft (2); the center of the rotary crankpin (1) is at a greater than zero distance (d2) from the center shaft's (2) center. When the center shaft (2) moves in a mechanical rotational motion, along with the pinion (3), it starts an XY two-dimensional motion.

In a different modality, the motion transmission requires pulleys; d2 is the distance between the rotary crankpin (1) and central shaft (2).

In a different modality, the rotary crankpin turntable has a gear-based motion transmission system for the rotary crankpin's (1) positioning.

In another modality, the rotary crankpin turntable has a belt-driven motion transmission system (B) that connects the main motion gears to position the rotary crankpin (1).

Similarly, the DIA point (5) could be any point in space where the tool will be placed and must be within an area of reach (6). The area of reach (6) will always contain this desired trajectory (7).

In another modality, the DIA point (5) can be any desired point in the XY plane, and/or the creation of a trajectory traced by defined points, within the area of reach (6). The area of reach (6) will always contain the desired trajectory (7).

In another modality, the desired trajectory's (7) velocity and acceleration required to reach the DIA points (5) are controlled with electric signals sent to at least two engines connected to the central shaft (2) and the pinion (3), respectively.

In another modality, the desired trajectory's (7) velocity and acceleration required to reach the DIA points (5) are controlled with electric signals sent to at least two engines connected to the central shaft (2) and the pinion (3), respectively.

On the other hand, the area of reach (6) is the area inside the subtraction of two concentric circles: Outer Concentric Circle (CC1), and Inner Concentric Circle (CC2); the desired trajectory (7) and the DIA points (5) are contained; the outer concentric circle (CC1) is the center of the rotary crankpin (1); and the center of inner concentric circle (CC2) is the center of the rotary crankpin (1).

At the same time, the area of reach (6) has the shape of a circular crown.

In a different modality, the present disclosure relates to a planetary system in which the subtraction of the radiuses of the outer concentric circle (CC2) and the inner concentric circle (CC2), equals the area of reach's (6) width.

In a different modality, the present disclosure relates to a planetary system, in which the subtraction of the radiuses of the outer concentric circle (CC1) and the inner concentric circle (CC2), equals the diameter of the stroke circle (c).

On the other hand, the area of reach's (6) width (d1) equals two times the distance between the rotary crankpin (1) and the center of the central shaft (2), and it follows the equation:

$$d 1 = d 2 \times 2 ;$$

d1 is the width of the area of range; and
d2 is the distance between the rotary crankpin (1) and the central shaft (2).

The stroke (C) is an imaginary circle whose radius is (d2)

In the same way, the diameter of the inner concentric circle (CC2) is always greater than zero.

The desired trajectory (7) includes the path from a DIA point (5) to another DIA point (5), and in which the desired trajectory (7) is defined by at least two DIA points (5).

### BRIEF DESCRIPTION OF THE DRAWINGS

FIG. 1 is a schematic view of the internal components of the actuator.

FIG. 2 is a schematic view of the actuator with its housing.

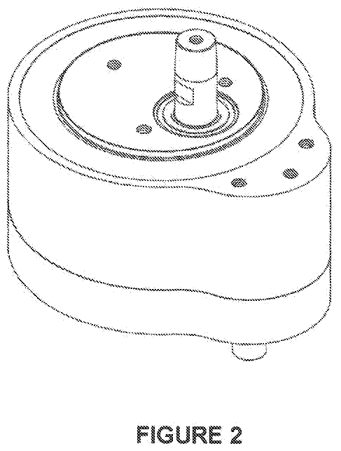

FIG. 3 is a schematic view of the actuator from above indicating an A-A longitudinal cut.

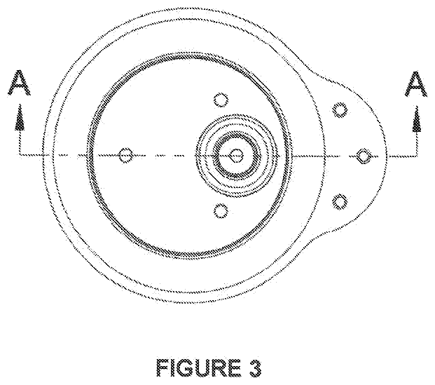

FIG. 4 is a side view of the longitudinal A-A cut of the actuator, in which the internal components of the present disclosure are pictured.

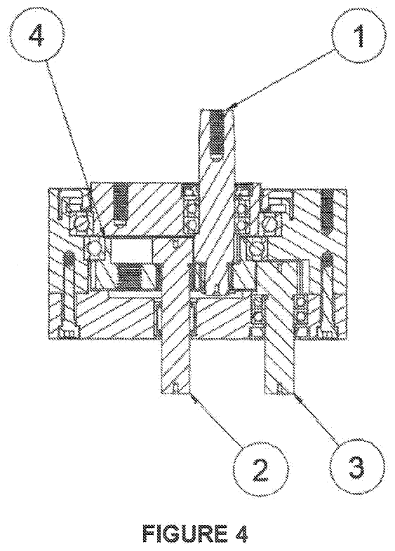

FIG. 5 is a schematic side view of the actuator indicating a B-B crosscut.

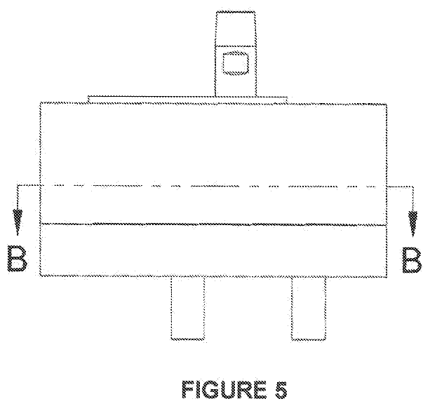

FIG. 6 is a view from above of the actuator with a B-B crosscut; its internal components are shown.

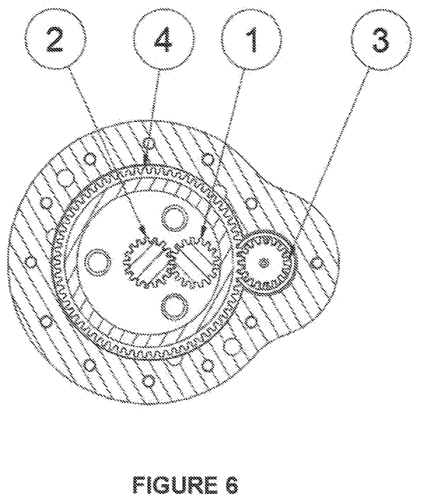

FIG. 7 is a schematic view showing the internal components of the actuator connected by belts (B).

FIG. 8 is a schematic view of the actuator's components from above; it shows the crown shaped area of reach (6).

FIG. 9 is a schematic view from above of the actuator's components; it shows the area of reach (6) when the diameter of the inner concentric circle (CC2) is close to zero.

FIG. 10 is a schematic view from above of the actuator's components; it shows that the diameter of the inner concentric circle (CC2) can grow as much as required to make the area of reach (6) larger.

### DETAILED DESCRIPTION

The actuator for XY coordinate access through planetary motion generates a desired trajectory (7) in one or more defined DIA points.

The present disclosure features two input shafts inside a rotation system. These can be rotated or activated through electric engines and software that applies an algorithm to rotate the rotary crankpin (1) in a controlled motion using two axes that move in coordination with an output shaft to move the rotary crankpin (1) following a desired trajectory (7). The programmed desired trajectory (7) always matches one or more defined DIA points (5).

The basic concept of the present disclosure is to move either the equipment itself or the product in process. This way the need to use robotic arms for repetitive automation is simplified.

The rotary crankpin turntable solves the need for a high precision system of repetitive and positioning motion in an XY plane. It is an alternative to automation systems involving complex mechanisms, programs, and specialized operation interphases.

A great advantage of the actuator is that it has fewer components than the previous state of the art. Besides, it does not require control software in certain applications.

Moreover, due to its smaller number of components, the device's life is longer, and its maintenance and calibration costs are lower.

The present disclosure can be used in micro-robotics, such as microelectronics, healthcare, pharmaceutics, watchmaking, etc., as well as in macro-robotics like mining, the automotive industry, aeronautics, etc. The actuator must be built according to the user's requirements. The geometry and components will always be the same, but its size and materials may vary.

Some examples of applications of the present disclosure are all kinds of adhesive applicators, including liquid, viscous or solid; welding of electronic circuit, components, or cables with any metal, paste or plasma; micro welding of integrated circuits; arc welding; tin welding; liquid shakers with any application in workshops, factories, and laboratories; paint applicators; template cutters for stickers, packaging, cardboard, steel, and plastic; screwdriver applications, sewing; watchmaking, etc.

The variables to consider to determine the size of the actuator are product or solution size, weight, and desired trajectory (7), which has to fit the actuator's area of reach (6). The size of the required actuator will be determined by the dimensions and weight of the product or solution, as well as the desired trajectory (7) of its application process; this will allow the area of reach (6) to fit within the desired trajectory (7).

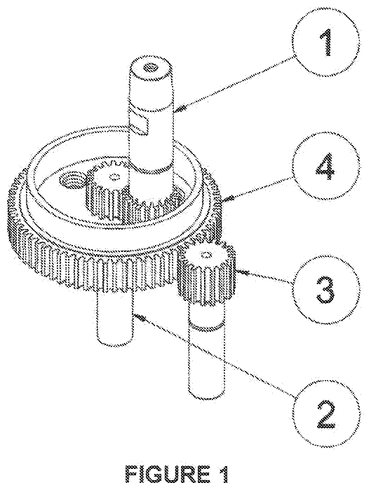

The actuator, in its basic form, includes four main components, as shown in FIG. 1. These components may vary in size, shape, and materials, depending on the specific requirements of the user, and variables such as dimensions and weight of the piece to work with. The actuator's physical features will depend on the size of the desired trajectory (7), as well as the weight and dimensions of the product or solution that will be processed in the application.

In another modality, the present disclosure can work with different types of mechanical transmission to connect the actuator's components, such as gears and transmission bands.

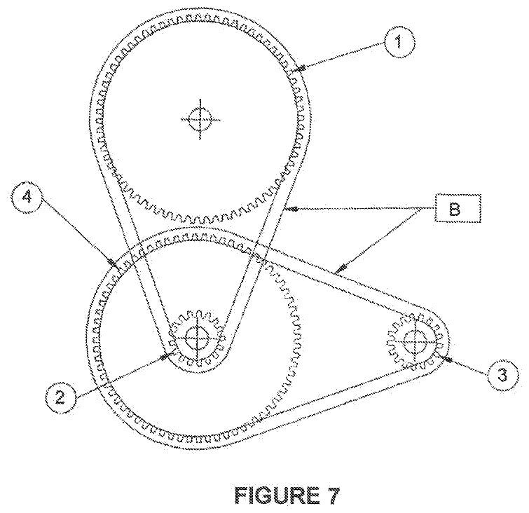

The actuator can include axes driven directly by gears, bands, or both, connecting the rotary crankpin's (1) main motion gears to position it depending on the specific application. This is shown in FIG. 7.

The loads, weights, required torque, and size of the product to be processed, will determine components such as pulleys, gears, bearings, axes and/or belts; as well as the materials required to assemble the rotary crankpin turntable.

As previously mentioned, the actuator is made up of at least four main components, shown in FIG. 1: rotary crankpin (1), center shaft (2), pinion (3), and transporter (4). Some accessories required by the application may vary or be added to the system, depending on the required implementation's performance.

The actuator's area of reach (6) is the plane bounded by two concentric circles where the desired trajectory (7) and the DIA points (5) must be contained. It has the shape of a circular crown or donut in a 2D plane, and it is contained between the two concentric circles CC1 and CC2; one of them is larger than the other.

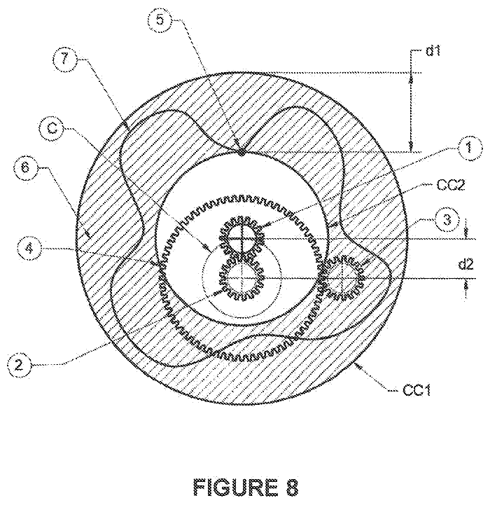

The subtraction of two concentric circles: outer concentric circle (CC2) minus inner concentric circle (CC2) is the area of reach (6), in which the desired trajectory (7) and the DIA points (5) are contained. To achieve the workpiece's motion, the outer concentric circle (CC1), and the center of the inner concentric circle (CC2), must match the center of the rotary crankpin (1). This is shown in FIGS. 8, 9, and 10.

It has been found that the area of reach's (6) width (d1) equals two times the distance between the center of the rotary crankpin (1) and the center of the center shaft (2); it follows the equation:

$$d 1 = d 2 \times 2 ;$$

d1 is the area of reach's width; and
d2 is the distance between the rotary crankpin (1) and the center shaft (2).

Additionally, the circular crown's position, or area of reach (6) can be defined according to the implementation needs of the system, and it extends to the outer concentric circle (CC1), which is the area of reach's (6) exterior limit; its interior limit is defined by the inner concentric circle (CC2).

In another modality, the present disclosure allows the use of a coordinate generator software to regulate the motions of two servos connected to the center shaft (2) and the pinion (3) respectively. The degrees of the rotations that feed the servos to generate the DIA points (5) and the desired trajectory (7) are calculated with an algorithm.

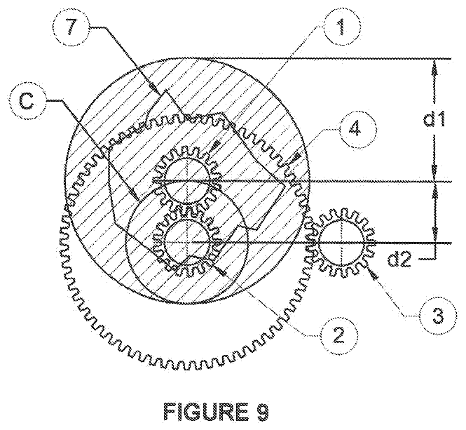

On the other hand, the inner concentric circle's (CC2) inner diameter can approach zero, but always must be greater than zero. At this point, the area of reach's (6) geometry approaches a circle; this is shown in FIG. 9.

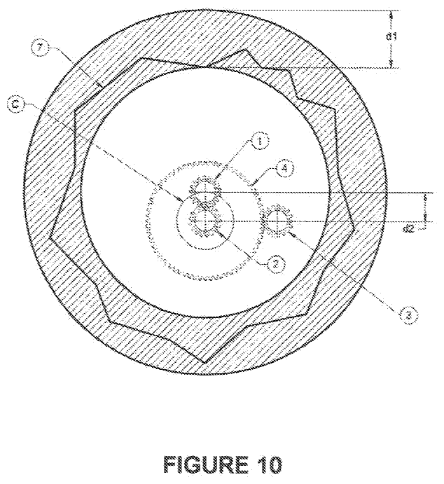

The area of reach's (6) outer concentric circle's (CC1) diameter can be as small as any value greater than two times the distance between the rotary crankpin (1) and the center shaft (2); the radius of the area of reach's (6) outer concentric circle (CC1) can grow from the rotary crankpin (1) as much as desired; this is shown in FIG. 10. This means that when the diameter of the inner concentric circle (CC2) grows, the area of reach (6) grows with it. Any desired trajectory (7) inside the area of reach (6) will be valid.

In another modality, the donut's center is the rotary crankpin (1); this is true for a setting with fixed equipment. With dynamic equipment, the donut's center is the center shaft (2).

It is important to emphasize that the DIA points (5) are different from the trajectory points. The DIA point (5) is where the device is placed; there can be more than one device.

In another modality, there are two possible settings for the DIA point (5): static and dynamic. In a static DIA point (5) setting, the DIA point (5) must be placed on the inner concentric circle (CC2), and thus, have multiple tools and multiple trajectories. The rotary crankpin (1) cannot go higher than the upper dead center. The dynamic setting is different. The DIA point is placed on the inner concentric circle's (CC2) perimeter, and the initial position of the DIA point (5) must be there too. For it to be an initial position, the center of the transporter (4) and the rotary crankpin (1) must be collinear. DIA point (5) is where the tool is placed, and trajectory points are the ones that make up the trajectory.

The construction of present disclosure is not limited by materials, appearance, or specific dimensions; the concept can be applied to a great number of possibilities for its application. The system can work with gears, belts, or both. Everything is under the same concept of planetary motion.

Regarding the processes, systems, and methods mentioned here; it must be clear that even though the steps have been explained as occurring in a certain sequence, they can happen in an order different to the one described. Furthermore, some of these steps could happen simultaneously, and other steps can be added, or omitted. In other words, the processes described in this document are to illustrate some examples and in no way should limit the claims.

Therefore, it must be clear that the description above is not restrictive, but illustrative. Many examples and different applications of the provided cases will be evident while reading the description above. The scope must be determined in reference to the claims in these documents, along with the full scope of equivalents to which the claims are entitled, and not just with the description above. It is expected to have future developments in the technologies discussed here, and the systems and methods described may be incorporated in future variants. In summary, it must be understood that this request can be modified.

All the terms used in these claims are intended to be used in their widest reasonable construction, and ordinary meaning, as understood by technicians of the subjects described in this document, unless there's an explicit instruction to the contrary. Particularly, the use of singular articles (“a”, “an”, “the”) must be understood to mention one or more of the indicated elements, unless a claim mentions an explicit limitation of the opposite.

It is noted that as of this date, the best method known to the applicant for taking the present disclosure into practice is the one made clear from the present description.

List of numeric references are provided in the table below:

| Ref. No. | Description |
|---|---|
| (1) | rotary crankpin |
| (2) | center shaft |
| (3) | pinion |
| (4) | transporter |
| (5) | DIA point(s) |
| (6) | area of reach |
| (7) | desired trajectory |
| (CC1) | outer concentric circle |
| (CC2) | inner concentric circle |
| (d1) | area of reach's width |
| (d2) | distance between the rotary crankpin (1) |
| | and the center shaft (2) |
| (B) | belts |
| (C) | stroke |

1. A two-dimensional (2D) rotary crankpin turntable actuator that generates a desired trajectory (7) in one or more defined dispensing-inspection-assembly (DIA) points (5), said rotary crankpin turntable actuator comprising
a rotary crankpin (1);
a center shaft (2);
a pinion (3); and
a transporter (4),
the center shaft (2) is mechanically connected to the rotary crankpin (1), and when it starts a rotational motion, it rotates the rotary crankpin (1),
wherein the pinion (3) is mechanically connected to the transporter (4), and when it starts a rotational motion, it rotates the transporter (4),
wherein the rotary crankpin (1) is mechanically connected to the transporter (4),
whose center is concentric with the center shaft (2),
wherein the center of the rotary crankpin (1) is at a greater than zero distance (d2) from the center shaft's (2) center, and
wherein when the center shaft (2) moves in a mechanical rotational motion, along with the pinion (3), it starts an XY two-dimensional motion.

2. The rotary crankpin turntable actuator according to claim 1, wherein
the distance (d2) is the distance between the centers of the rotary crankpin (1) and the center shaft (2).

3. The rotary crankpin turntable actuator according to claim 1, wherein the actuator comprises
a motion gear-based transmission system to position the rotary crankpin (1).

4. The rotary crankpin turntable actuator a cording to claim 1, wherein the actuator comprises
a motion transmission system that works with belts connecting the main motion gears to position the rotary crankpin (1).

5. The rotary crankpin turntable actuator according to claim 1, wherein
the DIA point(s) (5) comprises any point in space where work needs to be done and is within an area of reach (6).

6. The rotary crankpin turntable actuator a cording to claim 5, wherein
the area of reach (6) is contained within the desired trajectory (7).

7. The rotary crankpin turntable actuator a cording to claim 1, wherein
the desired trajectory's (7) velocity and acceleration to reach the DIA points (5) are controlled through electrical signals sent to at least two engines connected to the center shaft (2) and the pinion (3), respectively.

8. The rotary crankpin turntable actuator a cording to claim 5, wherein
the area of reach (6) is the area between the subtraction of the two concentric circles, wherein the two concentric circles comprise:
an outer concentric circle (CC1); and
an inner concentric circle (CC2),
wherein the desired trajectory (7) and the DIA points (5) are contained,
wherein the center of the outer concentric circle (CC1) is the center of the rotary crankpin (1), and
wherein the center of the inner concentric circle (CC2) is the center of the rotary crankpin (1).

9. The rotary crankpin turntable actuator a cording to claim 5, wherein
the area of reach (6) has a geometrical shape of a circular crown.

10. The rotary crankpin turntable actuator a cording to claim 5, wherein
the subtraction of the radii of the outer concentric circle (CC1) and the inner concentric circle's (CC2) is equal to the width (d1) of the area of reach (6).

11. The rotary crankpin turntable actuator a cording to claim 9, wherein the width (di) of the area of reach is equal to twice the distance between the centers of the rotary crankpin (1) and the center shaft (2), and follows the equation:
$$d 1 = d 2 \times 2 ,$$
wherein d1 is the width of the area of reach, and
wherein d2 is the distance between the rotary crankpin (1) and the center shaft (2).

12. The rotary crankpin turntable actuator a cording to claim 8, wherein
the inner concentric circle's (CC2) diameter is always greater than zero.

13. The rotary crankpin turntable actuator a cording to claim 1, wherein
the desired trajectory (7) is the path from one DIA point (5) to another, and the desired trajectory (7) is defined by at least two DIA points (5).
